(19) United States
(12) Patent Application Publication
(10) Pub. No.: US 2008/0181740 A1
(43) Pub. Date: Jul. 31, 2008

(54) DRILL BIT EXTENSION

(76) Inventor: Roland G. Waitszies, Bronx, NY (US)

Correspondence Address: ANTHONY L. MEOLA, ESQ., 66 INDIAN WELLS ROAD, BREWSTER, NY, 10509, US

(21) Appl. No.: 12/020,692

(22) Filed: Jan. 28, 2008

Related U.S. Application Data
(60) Provisional application No. 60/897,926, filed on Jan. 29, 2007.

(51) Int. Cl. B23B 31/10

(52) U.S. Cl. 408/226

(57) ABSTRACT

A drill bit extension device is disclosed for use with a quick release drill chuck, the device including a body portion for securing a replacement drill bit and a stem structured and arranged for insertion into the quick release drill chuck.

### BACKGROUND OF THE INVENTION

The present invention relates generally to a quick change drill bit extension and driver. More specifically the quick change drill bit extension allows for rapid replacement of drill bits into the drill extension without the need to operate a drill chuck.

Drill bit sets include bits of varying sizes. Prior art drill bit extension devices or adapters have included a precast drill chuck adapter molded together with the individual drill bit. With modern power drills, there is typically a quick change chuck allowing the user to quickly change a drill bit that includes the chuck adapter. A problem arises when a drill bit wears out or breaks and the user is left with a drill bit kit with less than all the necessary size drill bits. Currently, in order to replace the broken drill bit the user needs to purchase another entire set which is costly and wasteful.

As such there is exists a need for a replacement chuckless drill bit adapter designed for use with multiple sized drill bits.

### SUMMARY OF THE INVENTION

The present invention includes a chuckless drill bit adapter designed for use with multiple sized drill bits.

In one aspect, the present invention includes a drill bit extension device for use with a quick release drill chuck, the device including a body portion, a stem structured and arranged for insertion into the drill chuck and to be secured within the drill chuck, the stem connected to the body portion, the body portion includes an upper face and a lower face, the lower face for engaging with the drill chuck, the upper face including a drill bit bore substantially perpendicular thereto and for receiving a drill bit, a set screw bore substantially perpendicular to the drill bore, the set screw bore in gas communication with the clearance bore and for receiving a set screw to secure the drill bit within the main body portion.

In some embodiments the stem portion includes at least one undercut for engagement with the drill chuck. In some embodiments the clearance bore, the stem and the body portion are hexagonal shaped.

In some embodiments the stem is connected to the body portion with an undercut portion.

In some embodiments the device has a length of about 1.5 inches, the stem has a length of about 0.34 inches, the body portion has a length of about 0.3 inches, the clearance hole has a width of about 0.25 inches and a depth of about 0.53 inches.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows a side view of a drill bit extension device according to one embodiment of the present invention;

FIG. 2 show a rotated view of the drill bit extension device as shown in FIG. 1 according to one embodiment of the present invention; and

FIG. 3 shows an end view of the drill bit extension device as shown in FIG. 1 according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

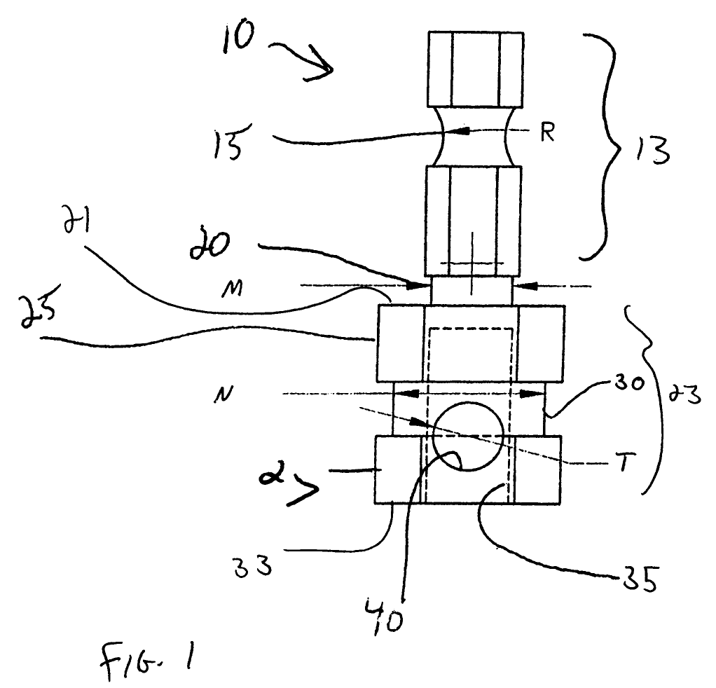

A feature of this invention is to allow users to quickly changes drill bit sizes while in a work environment without the need to purchase an entire set of molded quick release chuck drill bits. Referring now to FIG. 1 there is shown a side view of the drill bit extension device 10. Device 10 includes stem 13 on one end and a head portion 23 on the other end. Stem 13 includes under cut 15, such that when stem is inserted into the chuck of a drill, the tines of the chuck engage undercut 15 and secure device 10 to the drill. Undercut 15 is preferably shaped into an arcuate cylinder with radius R. Radius R is preferably about 0.18 inches but may be other dimensions and shapes in order to fit various size chucks.

Device 10 also includes transition undercut 20 between stem 13 and head portion 23. Undercut 20 provides an air gap between a drill chuck and the head portion 23 of device 13. Undercut 20 may serve as a weight saving measure as well as an additional undercut for some drill chucks to use as a grasping point. Undercut 20 is also preferably shaped into an arcuate cylinder with radius M. Radius M is preferably about 0.25 inches but may be other dimensions and shapes in order to fit various size chucks.

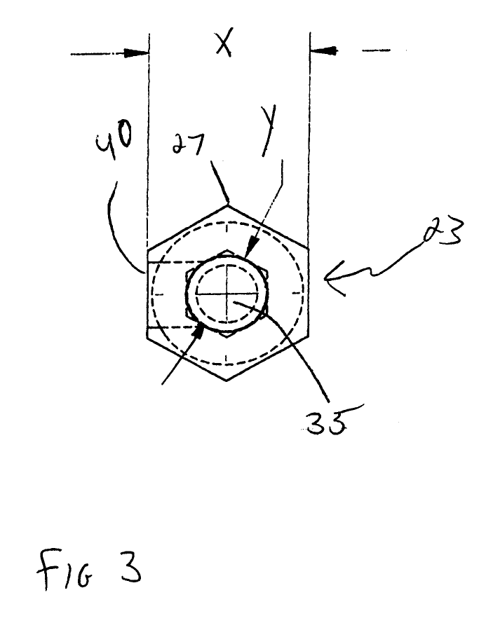

Head portion 23 is designed to capture and secure therein a replacement drill bit. Head portion further includes lower body portion 25 with a lower face 21. Lower face 21 is preferably a flat substantially smooth surface suitable for abutment up against the chuck of a drill. Head portion also includes undercut 30 which is preferably shaped into an arcuate cylinder with radius N. Radius N is preferably about 0.47 inches but may be other dimensions and shapes. Head portion 23 also includes upper body portion 27 with upper face 33. Lower portion 25 and upper portion 27 are preferably shaped with multiple flat sides and may be in a hexagonal pattern having a mean width X as shown in FIG. 3. Width X is preferably about 0.50 inches. Other shapes and sizes may work equally as well dependent upon the size of the drill bit to be retained within device 10.

Head portion 23 further includes clearance hole 35 bored substantially perpendicular to face 33. Clearance hole 23 is shaped and sized for receiving multiples sized and shaped drill bits (not shown). Set screw hole 40 is preferably bored through head portion 25 substantially perpendicular to clearance hole 35 and is gas communication with clearance hole 23. A set screw is not shown however any suitable screw may be employed to secure the drill bit once inserted into clearance hole 35.

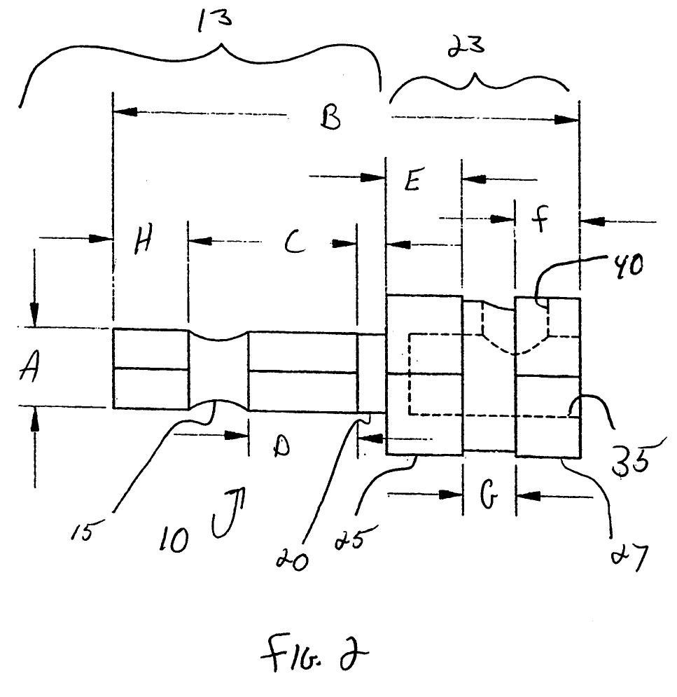

Referring now to FIG. 2 there is shown device 10 in a rotated view. In addition to the dimension described above, device 10 also has multiple dimensions as shown in FIG. 2 including A, B, C, D, E, F, G and H. Stem portion 13 is also preferably shaped with multiple flat sides and may be in a hexagonal pattern having a mean width A. Width A is preferably about 0.25 inches. Length B is preferably about 1.575 inches. Length C is preferably about 0.09 inches. Length D is preferably about 0.36 inches. Length E is preferably about 0.25 inches. Length F is preferably about 0.245 inches. Length G is preferably about 0.18 inches. Length H is preferably about 0.25 inches. Notwithstanding all of the preferred shapes, sizes and tolerances for each of the above-referenced dimensions, other shapes, sizes and tolerances, however work equally as well dependent upon the size of the drill bit to be retained within device 10 and the size and shape of the drill chuck receiving stem 13.

Referring now to FIG. 3 there is shown an end on view of device 10 as shown in FIG. 2. Head portion 23 can be shown with a hexagonal shape and a mean width dimension X. Preferable mean width X is about 0.50 inches. Clearance hole 25 has a radius Y, which is preferably about 0.250 inches. In addition, clearance hole may have a depth of about 0.53 inches. As stated above other sizes and shapes may be applied to these dimensions as well.

It will be apparent to one of skill in the art that described herein is a novel system and method for automatically modifying a language model. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A drill bit extension device for use with a quick release drill chuck, the device comprising:
a body portion;
a stem structured and arranged for insertion into the drill chuck and to be secured within the drill chuck, the stem connected to the body portion;
the body portion includes an upper face and a lower face, the lower face for engaging with the drill chuck, the upper face including a drill bit bore substantially perpendicular thereto and for receiving a drill bit, a set screw bore substantially perpendicular to the drill bore, the set screw bore in gas communication with the clearance bore and for receiving a set screw to secure the drill bit within the main body portion.

2. The device according to claim 1, where the stem portion includes at least one undercut for engagement with the drill chuck.

3. The device according to claim 1, where the clearance bore is hexagonal shaped.

4. The device according to claim 1 where the stem is hexagonal shaped.

5. The device according to claim 1 where the body portion is hexagonal shaped.

6. The device according to claim 1 where the stem is connected to the body portion with an undercut portion.

7. The device according to claim 1 where the device has a length of about 1.5 inches.

8. The device according to claim 1 where the stem has a length of about 0.34 inches.

9. The device according to claim 1 where the body portion has a length of about 0.3 inches.

10. The device according to claim 1 where the clearance hole has a width of about 0.25 inches and a depth of about 0.53 inches.
